(19) United States
(12) Patent Application Publication
(10) Pub. No.: US 2008/0243271 A1
(43) Pub. Date: Oct. 2, 2008

(54) SYSTEM AND METHOD FOR QUANTIFYING AN IMPROVEMENT IN AN ADVANCED PROCESS CONTROL STRATEGY

(76) Inventors: Ram Gandikota, Allen, TX (US); Dario Nappa, Plano, TX (US)

Correspondence Address: TEXAS INSTRUMENTS INCORPORATED, P O BOX 655474, M/S 3999, DALLAS, TX, 75265, US

(21) Appl. No.: 11/694,874

(22) Filed: Mar. 30, 2007

(51) Int. Cl. G05B 13/02

(52) U.S. Cl. 700/51

(57) ABSTRACT

An analysis application utilizes several quantitative metrics that characterize a controller's performance with respect to: specification limits, extreme values, and target and trend versus time. The application utilizes the metrics to provide statistical p-values.

### FIELD

The invention relates generally to systems and methods for process control.

### BACKGROUND

In manufacturing, such as semiconductor manufacture and fabrication, process control is utilized for controlling the output of a specific manufacturing or fabrication system and process. Typically, the process control involves statistical techniques to control the output of the manufacturing or fabrication process and to ensure that the process produces output, i.e. product, which stays within specified tolerances.

The process control may utilize various techniques, such as control theory, to control the output of the manufacturing or fabrication process. Control theory deals with the behavior of dynamic processes. In dynamic processes, the desired output of a system is called the target. When one or more output variables of a system need to follow certain targets over time, a controller, using process control, manipulates the inputs of a manufacturing process to obtain the desired effect on the output of the system.

One particular type of process control which utilizes control theory is advanced process control (APC). APC comprises different kinds of process control techniques, for example, model predictive control (MPC), statistical process control (SPC), Run2Run (R2R), fault detection and classification (FDC), sensor control and feedback systems. APC is often used for solving multivariable control problems or discrete control problems.

In addition to implementing a process control strategy, the process control strategy's performance must also be evaluated to ensure that the process control strategy is producing output that is optimal. Typically, the process control strategy is evaluated by comparing the output of a manufacturing process, using the control strategy, to a target output. For example, in the semiconductor fabrication, a process control strategy may be evaluated by comparing the product of the fabrication process to the specification of the product.

These comparisons often involve statistical analysis to compare output to the target output. One particular parameter utilized to evaluate a control process is the process capability index (Cpk). Cpk is defined as the lesser of

$$\frac{USL - Mean}{3 σ}$$

$$Or$$

$$\frac{LSL - Mean}{3 σ}$$

where σ is the estimated process standard deviation, USL and LSL are the upper and lower product specification limits, and mean is the mean value of the outputs. However, analyzing the comparisons of two process control strategies may be difficult and subjective. For example, it is difficult to interpret the Cpk for a process control strategy and it can be difficult to determine whether the difference between two Cpks is significant. Accordingly, methods are needed for quantitatively analyzing and comparing different process control strategies.

### SUMMARY

An embodiment is directed to a method of analyzing a process. The method comprises receiving data about multiple processes performed under at least two process control strategies, analyzing the data based on data from a target process; and comparing the analyzed data to determine one of the at least two process control strategies that performs the multiple processes substantially consistent with the target process.

Another embodiment is directed to a computer readable medium containing instruction for causing a processor to perform a method of analyzing a process. The method comprises receiving data about multiple processes performed under at least two process control strategies, analyzing the data based on data from a target process, and comparing the analyzed data to determine one of the at least two process control strategies that performs the multiple processes substantially consistent with the target process.

Another embodiment is direct to a system for analyzing a process. The system comprises a processor and an application. The application is configured for execution by the processor and comprises program instructions for receiving data about multiple processes performed under at least two process control strategies, analyzing the data based on data from a target process; and comparing the analyzed data to determine one of the at least two process control strategies that performs the multiple processes substantially consistent with the target process.

Additional embodiments of the disclosure will be set forth in part in the description which follows, and in part will be obvious from the description, or may be learned by practice of the present disclosure. The embodiments of the disclosure will be realized and attained by means of the elements and combinations particularly pointed out in the appended claims.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate embodiments of the disclosure and together with the description, serve to explain the principles of the embodiments.

FIG. 1 is a diagram illustrating an exemplary system for performing process control strategy analysis consistent with embodiments of the present disclosure.

FIG. 2 is a flow diagram illustrating an exemplary method of process control strategy analysis consistent with embodiments of the present disclosure.

FIG. 3-5 are diagrams illustrating exemplary results of process control strategy analysis consistent with embodiments of the present disclosure.

FIGS. 6 and 7 are diagrams illustrating an example of an analysis of process control strategies consistent with embodiments of the present disclosure.

### DETAILED DESCRIPTION

Embodiments of the present disclosure provide an improved process for analyzing a process control strategies such as advanced process control (APC). According to embodiments, an analysis application utilizes several quantitative metrics that characterize a controller's performance with respect to: specification limits, extreme values, and target and trend versus time. The application utilizes the metrics to provide statistical p-values. By utilizing the quantitative metrics, the analysis application provides a precise and rigorous process to quantify improvements obtained with a new process control strategy when compared with a reference control strategy.

Reference will now be made in detail to the exemplary embodiments of the present disclosure, an example of which is illustrated in the accompanying drawings. Wherever possible, the same reference numbers will be used throughout the drawings to refer to the same or like parts.

In the following description, reference is made to the accompanying drawings that form a part thereof, and in which is shown by way of illustration specific exemplary embodiments which may be practiced. These embodiments are described in sufficient detail to enable those skilled in the art to practice the embodiments and it is to be understood that other embodiments may be utilized and that changes may be made without departing from the scope of the invention. The following description is, therefore, merely exemplary.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all sub-ranges subsumed therein. For example, a range of “less than 10” can include any and all sub-ranges between (and including) the minimum value of zero and the maximum value of 10, that is, any and all sub-ranges having a minimum value of equal to or greater than zero and a maximum value of equal to or less than 10, e.g., 1 to 5.

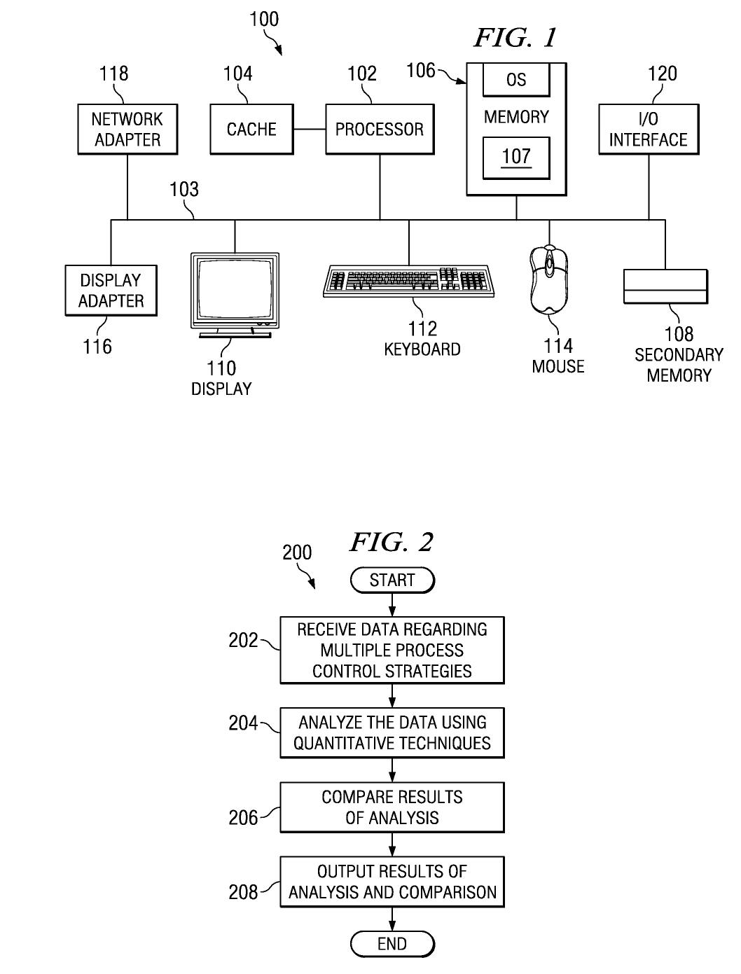

FIG. 1 is a block diagram of an exemplary computing platform 100 capable of performing embodiments of the present disclosure. Computing platform 100 may be utilized to perform the processes of the present disclosure.

As shown in FIG. 1, computing platform 100 may include components such as a processor 102, a cache 104, a memory 106, a secondary memory 108, a display 110, a keyboard 112, a mouse 114, a display adaptor 116, a network adaptor 118, and input/output (I/O) interface 120. Each of these components may be coupled and communicate via a bus 103.

Processor 102 may be embodied in one or more processors. Processor 102 provides an execution platform for applications performing methods of the present disclosure. Commands and data from the processor 102 may be communicated over communication bus 103 to and from main memory 106. Main memory 106 may be, for example, a Random Access Memory (RAM). Main memory 106 may store an operating system (OS).

Main memory 106 may also store an analysis application 107 implementing the methods of the present disclosure, which may be executed during runtime by processor 102. Analysis application 107 may be written in program code and executed by the computing platform 100. Analysis application 107 may be implemented in computer languages such as PASCAL, C, C++, JAVA, HTML and the like. One skilled in the art will realize that the methods described above may be implemented in any computer language and any application capable of designing semiconductor devices.

Additionally, one skilled in the art will realize that analysis application 107 may be embodied on any computer readable storage medium as instruction for causing computer platform 100 to perform the instructions. The computer readable storage medium may include storage devices and signals, in compressed or uncompressed form. Exemplary computer readable signals, whether modulated using a carrier or not, are signals that a computer system hosting or running the present invention can be configured to access, including signals downloaded through the Internet or other networks. Concrete examples of the foregoing include distribution of executable software programs of the computer program on a CD-ROM or via Internet download. In a sense, the Internet itself, as an abstract entity, is a computer readable medium. The same is true of computer networks in general.

Likewise, analysis application 107 implementing the method of the present disclosure may be stored on secondary memory 108. Secondary memory 108 may include, for example, one or more of a hard disk drive and/or a removable storage drive, a floppy diskette drive, a magnetic tape drive, a compact disk drive, and the like. Computer platform 100 may read from and/or write to secondary memory 108. Likewise, multiple secondary memories 108 may read from and/or write between themselves in a well-known manner.

Users of computing platform 100 may interface with and control computing platform 100 utilizing keyboard 112 and mouse 114. Computing platform 100 may utilize display 110 and display adapter 116 to output data, such as the mask layout, for viewing by the users. For example, display adapter 116 may receive display data from the processor 102 and convert the display data into display commands for display 110.

Network adapter 118 may allow computing platform 100 to send and receive data via a network. Additionally, I/O interface 120 may allow computing platform 100 to input data from and output data to other electronic devices. For example, I/O interface 120 may be coupled to a controller or manufacturing system, such a controller for a semiconductor fabrication system or the system itself, in order to receive controller data and transmit the results of the processes of the present disclosure.

Analysis application 107 accepts data in order to perform analysis on the process control strategy of the controller. The data utilized by analysis application 107 may be computer files including information about a process control strategy. The data may include data about the output, i.e. product, of a manufacturing or fabrication process. For example, the data may be the specification of a semiconductor device from a semiconductor fabrication process and the reference specification of the semiconductor device.

Analysis application 107 utilizes several quantitative metrics that characterize a process control strategy of a controller with respect to: specification limits, extreme values, and target and trend versus time. Analysis application 107 analyzes the performance by determining several factors such as Cpkm, closeness, extreme value, and coherence length. Analysis application 107 utilizes these factors to determine the usefulness of the new control process.

FIG. 2 is a flow diagram illustrating a method 200 for analyzing a process control strategy. Method 200 may be performed by analysis application 107. Analysis application 107 utilizes several quantitative metrics that characterize the output of a process control strategy with respect to: specification limits, extreme values, and target and trend versus time.

Method 200 begins with analysis application 107 receiving data from multiple process control strategies (stage 202). The data may include data about the output, i.e. product, of a manufacturing or fabrication process. For example, the data may be the specification values of a semiconductor device from a semiconductor fabrication process and the reference specification values of the semiconductor device.

Next, analysis application 107 analyzes the data using quantitative techniques (stage 204). Analysis application 107 utilizes several quantitative metrics that characterize a process control strategy with respect to: specification limits, extreme values, and target and trend versus time. Analysis application 107 analyzes the performance by determining several factors such as Cpkm, closeness, extreme value, and coherence length. These factors will be discussed below.

Cpkm

Any process control strategy attempts to achieve values for its output as close to the values for the target as possible. For example, in semiconductor fabrication, any process control strategy attempts to produce semiconductor devices with specification values as close to the reference specification as possible. Any two control processes may have the same Cpk. However, given two control process with the same Cpk, a more desirable process provides multiple values closer to the target. The Cpkm provides a quantitative measure of two process control strategies even when the processes have the same Cpk. Cpkm takes into account the value of multiple outputs of the control processes.

Cpkm may be given by the formula

$$Cpkm = min \{ \frac{USL - mean}{3 {σ}_{m}} , \frac{mean - LSL}{3 {σ}_{m}} \}$$

$$Where$$

$${σ}_{m} = \sqrt{\frac{\sum {( {X}_{i} - T )}^{2}}{n - 1}}$$

$$And$$

$$T = process target .$$

As seen in the formula that defines the Cpkm, as the values Xᵢ differ from target then the standard deviation σₘ increases and as result the Cpkm decreases.

Closeness

Closeness measures the fraction of times in which a new control process strategy produces output values closer to the target value than the baseline control process strategy. Closeness may be given by the formula

$$Closeness = \frac{Times\_New \_Process \_Clear}{Total\_Number \_of \_Data}$$

Times_New_Process_Closer represents the number of times that the new process control strategy produces output values closer to the target value. Total_Number_of_Data represents the total number of output values. As such, if the new process control strategy provides values closer to the target more often than the baseline process control strategy, closeness is greater than 0.50.

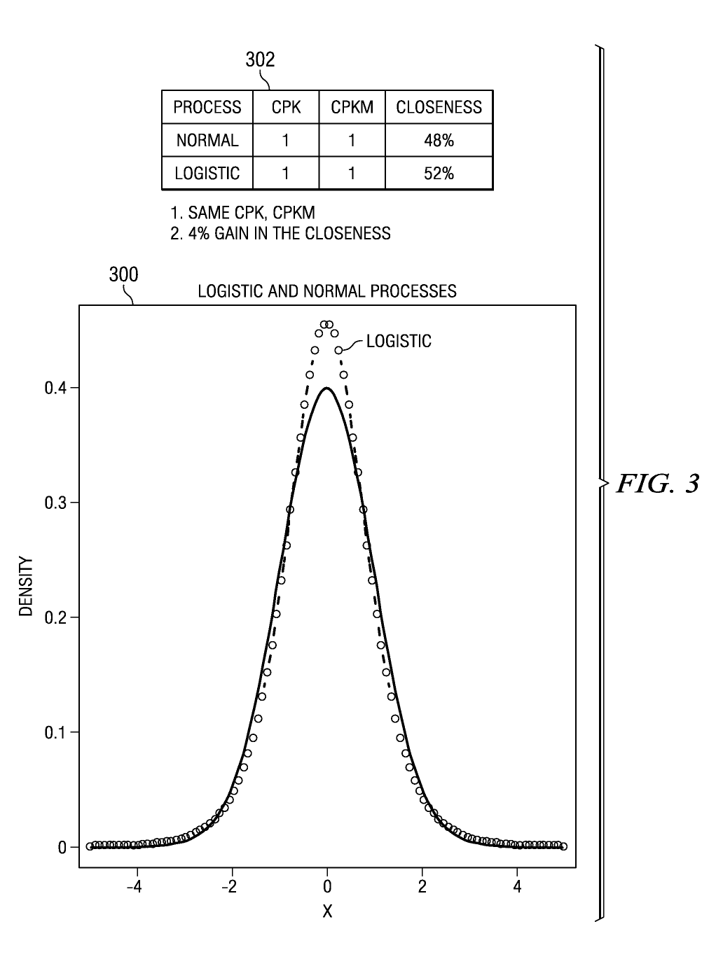

FIG. 3 is a graph 300 illustrating an exemplary closeness determination versus Cpk and Cpkm. As shown, graph 300 shows the values of output for two exemplary process control strategies. One process control strategy has a normal distribution and the other has a logistic distribution. The x-axis of graph represents deviation from the target process, with zero representing the target value.

As illustrated, the logistic process control strategy has a higher peak at zero. Logistic process control strategy provides more values for the output closer to the target. As such, logistic process control strategy may be determined to be a better process.

Also, as illustrated, the Cpk and Cpkm for both process control strategies do not show any difference. Table 302 on the right side shows that both process control strategies have a Cpk=Cpkm=1.0. By utilizing the closeness, analysis application 107 may determine that the logistic process control strategy has a closeness of 52%. When compared to the other process control strategy, the logistic process control strategy has a 4 percent (52%-48%=4%) more chance to be closer to the target value. As such, this translates to about 8% (4/48=1/12) improvement in the process performances.

Extreme Value Statistics

In comparing two process control strategies, a new process control strategy should not provide more extreme value for the outputs than the baseline process. An extreme value of the output is defined as one processes output whose value varies greater or smaller from the target than the other processes output. The extreme values statistics may be given by the equation

$$Extreme\_Values \_Statistics = \frac{Times\_New \_process \_has \_more \_extreme \_values}{Total\_extreme \_values}$$

The statistics considers the tails of the distribution and calculates the fraction of times that the new process control strategy has more extreme values outputs than a baseline process control strategy. Total_extreme_values represents the number of outputs that are considered as extreme. For example, we can define as extreme value outputs the 10 outputs from both processes with values that vary the most above or below the target. One skilled in the art will realize that the number of 10 outputs is exemplary and that any number of outputs may be selected in defining extreme value outputs.

Times_New_process_has_more_extreme is the number of extreme value outputs from the new process control strategy that vary further from the target than the baseline process control strategy. If the new process control strategy has a higher number of extreme value outputs than the baseline process, the Extreme_Values_Statistics is greater than 0.5. For example, if the bottom 10 observations can be considered as extreme value outputs, and 3 of those are from the new process, then the Extreme_Values_Statistics=3/10=0.30.

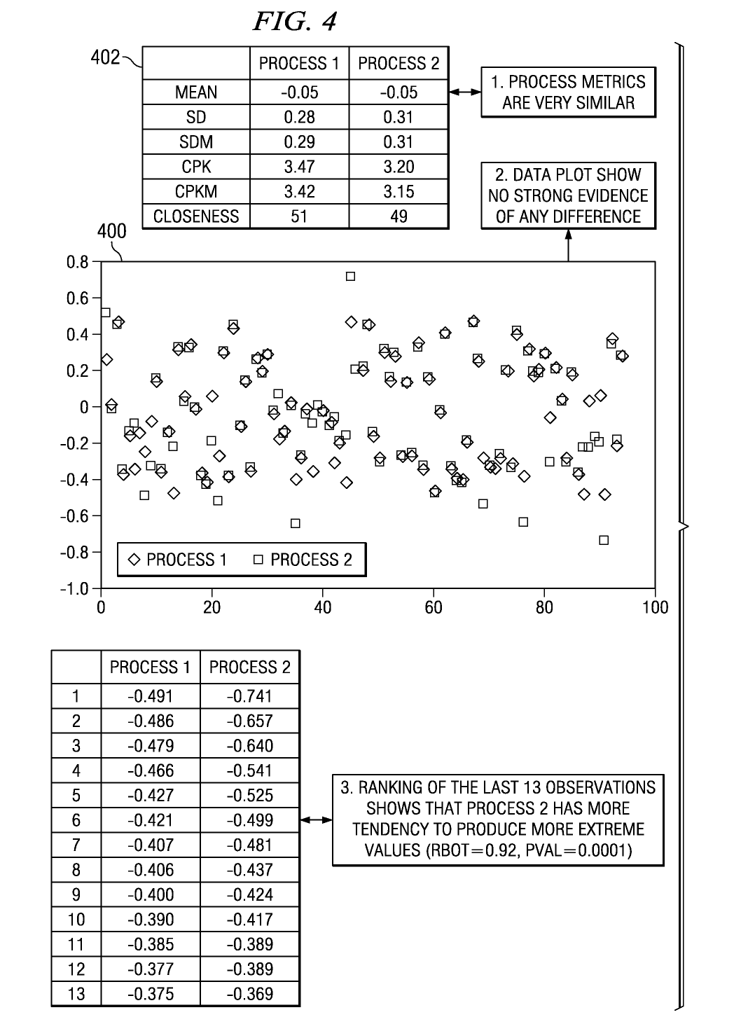

FIG. 4 is a graph 400 illustrating the extreme value statistics two exemplary process control strategies, Process 1 and Process 2. As illustrated, Process 2 provides values too large or too small relative to the target process. A typical approach in analyzing Process 1 and Process 2 would be to compare the Cpk.

As shown in table 402, Process 1 has a Cpk of 3.47 and Process 2 has a Cpk 3.20. Given the small number of data points, it may be difficult to determine if one process is better than the other. The extreme value statistics gave a value of 0.92 and a P-value of 0.0001. As such, analysis application 107 may determine that Process 2 may not be as ideal as Process 1 because Process 2 produces more extreme values.

Coherence Length

A new process control strategy should provide values of the output evenly on either side of a target. Too many outputs with values on a particular side (less than or greater than) of the target is not desirable. A coherence length is the fraction of successive output for which the values of the process is on one side of the target value. The coherence length may be given by

$$Coherence\_Length = \frac{Max\_number \_of \_runs \_in \_one \_side}{Max\_number \_of \_runs \_in \_one \_side + 2}$$

Max_number_of_runs_in_one_side is the maximum number of values of the outputs in one side of the target. For example, if an output has values of −1,1,2,−3,−2,1,2,3,1,1,−1,1,−2, starting from the 6^{th} observations, the process control strategy produces a sequence of four outputs with values on the same side. As such, the coherence length is 6/8=0.75. Theoretically, a process control strategy should have some values above and some values below the target. If all values are above the target, the process control strategy may be producing errors. A process control strategy with the Coherence_Length equal to 0.50 is ideal.

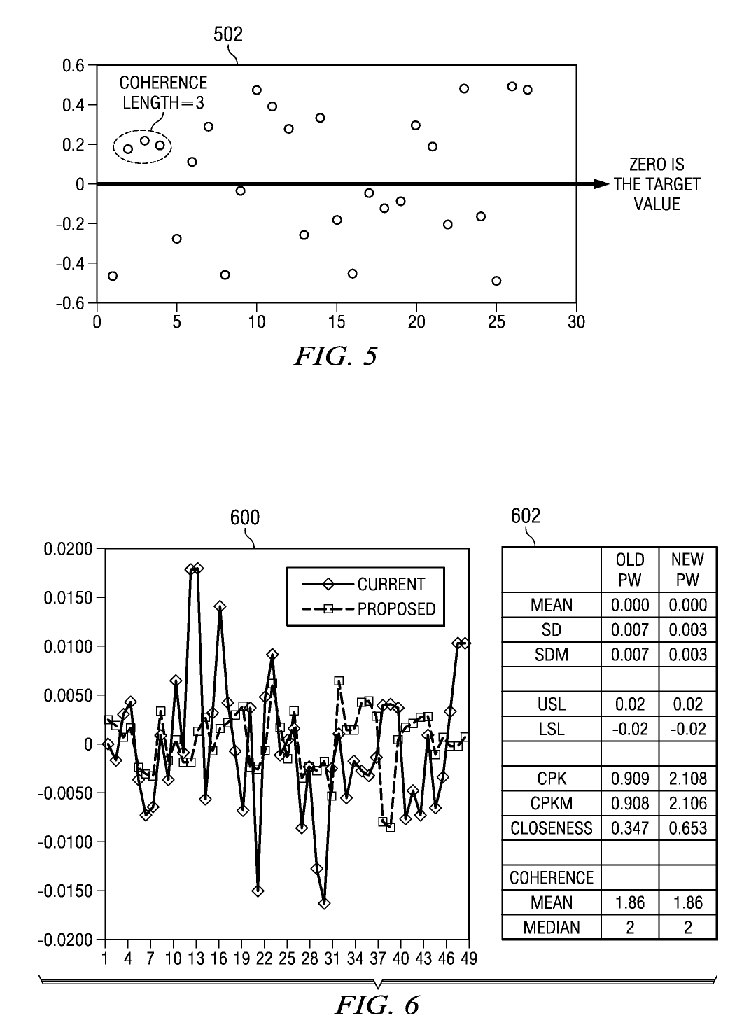

FIG. 5 is a graph 502 illustrating coherence length for an exemplary process control strategy. As illustrated, the process control strategy produces a sequence of three points that are larger than the target value. As such, process control strategy may be determined to have a coherence length of 3.0.

After the analysis performed, analysis application 107 compares the process control strategies (stage 206). Analysis application 107 may utilize the set of four statistics described above to compare the new and baseline process control strategy.

Overall a new process strategy should have similar better performances than the previous process control strategy. Analysis application 107 may compare the new process strategy to the baseline process control strategy by directly comparing Cpkm, closeness, extreme value statistic, and coherence length.

Additionally, analysis application 107 may compare each process control strategy using the statistical p-values related to the various statistics. The p-value is the probability to have a certain statistics (for example certain Extreme values) assuming that there is no difference between new and old process control strategy. One skilled in the art will realize that the p-values may be calculated using the standard statistical procedures.

After comparing the process, analysis application 107 may output the results of the analysis and comparison (stage 208). One skilled in the art will realize that analysis may output the results to any system capable of communicating with analysis application 107 and system 100.

Example of the Process

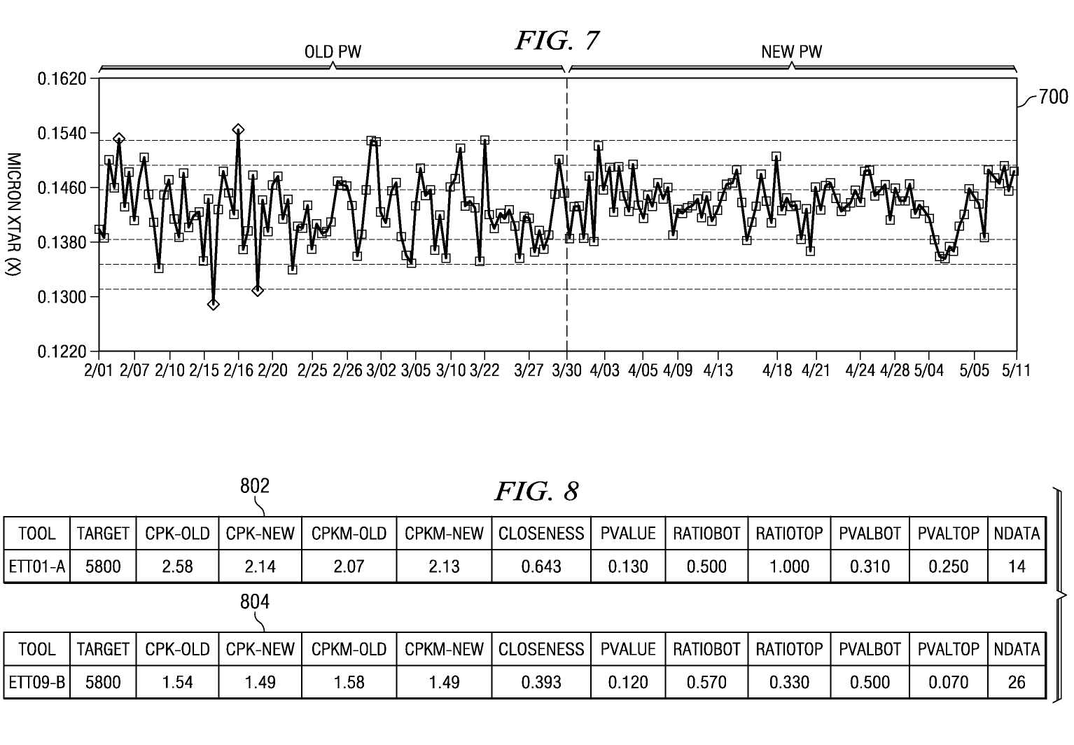

FIGS. 6 and 7 are a graph 600 and graph 700 illustrating the analysis for two exemplary process control strategies (OLD PW and New PW) in a semiconductor gate etch process. In this example, Old PW may represent a process control strategy currently used in the gate etch and New PW may represent a proposed process control strategy. The data plotted in graph 600 represents the deviation in the output product from the etch process from the target specification for Old PW and New PW.

As shown in table 602, New PW has higher Cpk and Cpkm which may indicate that New PW is better. Further, the larger closeness values (0.653 versus 0.347) for the New PW may indicate that the proposed process control strategy provides values closer to the target values. Also, the same coherence values (1.86) means that the New PW does not change how often the process deviates on one side or the other side of the target value.

FIG. 8 is a diagram illustrating tables 802 and 804 that include analysis of two exemplary process control strategies (old and new) performed on different etch apparatus. As shown in table 802, the Cpk shows that the old process control strategy is better than the new process control strategy. However, the closeness shows that in 64% of cases the new process control strategy is better than the old one. As such, the new process control strategy may be determined to be better because the difference in Cpk could be driven by outliers.

As shown in table 804, the Cpk and Cpkm do not show evidence of a difference between the old process control strategy and the new process control strategy. However, the closeness shows that for only 39% of the data points the new process control strategy is better than the old process control strategy and the Ratio-top statistics show that the new process control strategy tends to produce more points in the upper part of the target specifications.

Other embodiments of the present teaching will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method of analyzing a process, comprising:
receiving data about multiple processes performed under at least two process control strategies;
analyzing the data based on data from a target process; and
comparing the analyzed data to determine one of the at least two process control strategies that performs the multiple processes substantially consistent with the target process.

2. The method of claim 1, further comprising:
outputting the analyzed data and the comparison of the analyzed data.

3. The method of claim 1, wherein analyzing the data comprises:
determining an amount each of the at least two processes deviates from the target process.

4. The method of claim 1, wherein analyzing the data comprises:
determining a fraction of a number of the multiple process from a first of the at least two processes deviates less from the target process.

5. The method of claim 1, wherein analyzing the data comprises:
determining a fraction of a number of the multiple processes from a first of the at least two processes deviates more from the target process.

6. The method of claim 1, wherein analyzing the data comprises:
determining a fraction of a number of the multiple processes from a first of the at least two processes deviates sequentially less or more from the target process.

7. The method of claim 1, wherein comparing the analyzed data comprises performing a statistical analysis on the analyzed data to determine a probability that one of the at least two processes will perform the multiple processes closer to the target process.

8. A computer readable medium containing instruction for causing a processor to perform a method of analyzing a process, the method comprising:
receiving data about multiple processes performed under at least two process control strategies;
analyzing the data based on data from a target process; and
comparing the analyzed data to determine one of the at least two process control strategies that performs the multiple processes substantially consistent with the target process.

9. The computer readable medium of claim 8, further comprising:
outputting the analyzed data and the comparison of the analyzed data.

10. The computer readable medium of claim 8, wherein analyzing the data comprises:
determining an amount each of the at least two processes deviates from the target process.

11. The computer readable medium of claim 8, wherein analyzing the data comprises:
determining a fraction of a number of the multiple process from a first of the at least two processes deviates less from the target process.

12. The computer readable medium of claim 8, wherein analyzing the data comprises:
determining a fraction of a number of the multiple processes from a first of the at least two processes deviates more from the target process.

13. The computer readable medium of claim 8, wherein analyzing the data comprises:
determining a fraction of a number of the multiple processes from a first of the at least two processes deviates sequentially less or more from the target process.

14. The computer readable medium of claim 8, wherein comparing the analyzed data comprises performing a statistical analysis on the analyzed data to determine a probability that one of the at least two processes will perform the multiple processes closer to the target process.

15. A system for analyzing a process, the system comprising:
a processor; and
an application configured for execution by the processor comprising program instructions for receiving data about multiple processes performed under at least two process control strategies, analyzing the data based on data from a target process; and comparing the analyzed data to determine one of the at least two process control strategies that performs the multiple processes substantially consistent with the target process.

16. The system of claim 15, further comprising:
a memory coupled to the processor for storing the application.

17. The system of claim 15, further comprising:
an output coupled to the memory outputting the analyzed data and the comparison of the analyzed data.
